(19) United States
(12) Patent Application Publication
(10) Pub. No.: US 2023/0294362 A1
(43) Pub. Date: Sep. 21, 2023

(54) METHOD AND 3D PRINTING APPARATUS FOR PRODUCTION OF A LUMINAIRE, AND A LUMINAIRE

(71) Applicant: SIGNIFY HOLDING B.V., EINDHOVEN (NL)

(72) Inventors: Wilhelmus Cornelis KEUR, WEERT (NL); Hendrikus Hubertus Petrus GOMMANS, MEEUWEN (NL); Rifat Ata Mustafa HIKMET, EINDHOVEN (NL)

(21) Appl. No.: 18/018,160

(22) PCT Filed: Jul. 16, 2021
(86) PCT No.: PCT/EP2021/069994

§ 371 Date: Jan. 26, 2023

(30) Foreign Application Priority Data
Aug. 3, 2020 (EP) 20189092.8

(51) Int. Cl. B29C 64/393

(52) U.S. Cl. CPC B29C 64/393; B33Y 10/00

(57) ABSTRACT

A method for determining a production of a luminaire (100) via 3D-printing, and a 3D-printing apparatus for production of a luminaire, and a luminaire, are provided. The method comprises the steps of defining a suspension point (110) of the luminaire, defining a fixation line (120) through the luminaire, defining a plurality of cross-sectional shapes (130) of the luminaire along the vertical axis, z, and for each cross-sectional shape of the plurality of cross-sectional shapes of the luminaire, minimizing a distance, R0, between the fixation point and a center of mass, Mt, of a first sector, S₁, and a second sector, S₂, of the cross-sectional shape.

### FIELD OF THE INVENTION

The present invention generally relates to the field of 3D printing. More specifically, the present invention relates to a method for determining a production of a luminaire and a 3D-printing apparatus for production of a luminaire, wherein the luminaire is intended for vertical suspension.

### BACKGROUND OF THE INVENTION

Additive manufacturing, sometimes also referred to as 3D printing, refers to processes used to synthesize a three-dimensional object. 3D printing is rapidly gaining popularity because of its ability to perform rapid prototyping without the need for assembly or molding techniques to form the desired article.

By using a 3D-printing apparatus, the article or object may be built in three dimensions in a number of printing steps that are usually controlled by a computer model. For example, a sliced 3D model of the object may be provided in which each slice is recreated by the 3D-printing apparatus in a discrete printing step. The 3D-printing apparatus may extrude successive layers of an extrudable material from a dispenser, and the layers may be cured or otherwise hardened after extrusion (deposition), e.g. using a laser to induce the curing process.

The most widely used additive manufacturing technology is the process known as Fused Deposition Modeling (FDM). It will be appreciated that other terms for FDM are “fused filament fabrication” (FFF) or “filament 3D printing” (FDP), which are considered to be equivalent to FDM. FDM is an additive manufacturing technology commonly used for modeling, prototyping, and production applications. FDM works on an “additive” principle by laying down material in layers: a plastic filament or metal wire may be unwound from a coil and be deposited to produce an object. Possibly, e.g. for thermoplastics, the filament may be melted and extruded before being deposited. In general, FDM printers use a thermoplastic filament, which is heated to its melting point and then extruded, layer by layer (or filament after filament) to create a three-dimensional object.

FDM is a rapid prototyping technology, meaning that FDM printers are relatively fast, cost-efficient and can be used for printing relatively complicated objects. For example, the FDM technique may be used for manufacturing luminaires and lampshades in different sizes and designs.

From an aesthetic point of view, it is typically not appreciated that, when suspended, lampshades are to tilt in any direction. Therefore, lampshades are typically symmetric in all directions when installed to the ceiling from their fixation point. In other words, these lampshades are usually symmetric along a direction parallel to the gravitational field to prevent the lampshade from tilting due to an unbalanced weight distribution.

In order to overcome this problem, a straightforward solution is to introduce additional suspension points to the lampshade. However, this may not be aesthetically desirable in certain designs. To meet the required balanced weight distribution, the center of mass of the lampshade should coincide with its suspension point. In order to achieve this, different components of the luminaire may be distributed on either side of the suspension point to achieve the desired weight balance. However, it should be noted that lampshades often comprise very few exterior components, or even none at all. Hence, alternative solutions are of interest, which are able to provide lampshades and/or luminaires which are balanced when vertically suspended.

### SUMMARY OF THE INVENTION

It is an object of the present invention to overcome this problem, and to provide a method for determining a production of a luminaire and a 3D printing apparatus for production of a luminaire, wherein the luminaire is balanced when vertically suspended.

According to a first aspect of the present invention, there is provided a method for determining a production of a luminaire via 3D-printing, wherein the luminaire is intended for vertical suspension. The method comprises the step of defining a suspension point of the luminaire, the suspension point being an exterior point of the luminaire by which the luminaire is intended to be vertically suspended. The method further comprises the steps of defining a fixation line through the luminaire, the fixation line elongating from the suspension point and being parallel to a vertical axis, z, and defining a plurality of cross-sectional shapes of the luminaire along the vertical axis, z, wherein each cross-sectional shape of the plurality of cross-sectional shapes extends in a plane, P, perpendicular to the vertical axis, z, and corresponds to a 3D-printing layer of the luminaire. The method further comprises the steps of, for each cross-sectional shape of the plurality of cross-sectional shapes of the luminaire: defining a fixation point as the intersection of the fixation line with the cross-sectional shape, defining a mass balance line in the plane, P, wherein the mass balance line intersects the fixation point, defining a first side and a second side of the cross-sectional shape with respect to the mass balance line, respectively, wherein the first side and the second side are arranged opposite to each other with respect to the mass balance line, and defining a sector angle, dφ=180°/n, wherein n is an integer. The method further comprises the steps of, for each angle φ=k·dφ, wherein k=1, . . . , n, determining an extrusion of 3D-printing material of the cross-sectional shape as a function of a first sector, S₁, of the sector angle, dφ, at the angle, φ, in the first side, wherein the first sector, S₁, is associated with a first mass, m₁, of extruded 3D-printing material, and a second sector, S₂, of the sector angle, dφ, at the angle φ+180°, in the second side, wherein the second sector, S₂, is associated with a second mass, m₂, of extruded 3D-printing material, for minimizing a distance, R₀, between the fixation point and a center of mass, Mₜ, of the first sector, S₁, and the second sector, S₂. In case the distance, R₀, exceeds a predetermined threshold distance, Rₜ, the method further comprises the steps of defining a connection line in the plane, P, intersecting the center of mass, Mₜ, and the fixation point, wherein, in case the center of mass, Mₜ, is located in the first side, determining an additional extrusion of 3D-printing material of the cross-sectional shape in the second side such that a first center of mass, M_{S1}, of the determined additional extrusion of 3D-printing material of the cross-sectional shape of the second side coincides with the connection line in the second side and is located at a first distance, R_{S1}, from the fixation point, for minimizing |M_{S1}·R_{S1}−Mₜ·R₀|, and wherein, in case the center of mass, Mₜ, is located in the second side, determining an additional extrusion of 3D-printing material of the cross-sectional shape in the first side such that a second center of mass, M_{S2}, of the determined additional extrusion of 3D-printing material of the cross-sectional shape of the first side coincides with the connection line in the first side and is located at a second distance, R_{S2}, from the fixation point, for minimizing |M_{S2}·R_{S2}−Mₜ·R₀|.

Thus, the present invention is based on the idea of solving a mass balance equation for each cross-sectional shape in order to mass balance the luminaire with respect to the fixation point. By this, it is meant that the mass of the luminaire by the 3D-printing material to be extruded is distributed such that the resulting center of mass of the cross-sectional coincides with the fixation point. By minimizing the distance, R₀, between the fixation point and the center of mass of the first and second sector, it is intended that the center of mass of the cross-sectional shape may be very close to, or preferably may coincide with the fixation point of the cross-sectional shape in order to achieve a balanced luminaire when vertically suspended.

The present invention is advantageous in that the method may efficiently and conveniently determine the weight distribution of the luminaire to be 3D printed in order to obtain a balanced luminaire when vertically suspended. In other words, by method of the present invention, a luminaire may be obtained which does not tilt when suspended e.g. from a ceiling.

The present invention is further advantageous in that due to the balanced luminaire as a result of the method, only one suspension point of the luminaire may be needed when mounted. Consequently, this results in a more conveniently arranged and/or suspended luminaire. Furthermore, the luminaire may be more aesthetically appealing.

The present invention is further advantageous in that the method may efficiently and conveniently save 3D-printing material in the production of the luminaire. In other words, the method of the present invention may achieve a minimum of residual 3D-printing material upon production of the luminaire.

It is preferred that R₀ is approximated to zero, preferably equated to zero, so that the center of mass may coincide with the fixation point of the cross-sectional shape. However, R₀ may be higher than a predetermined threshold, i.e. the mass of the cross-sectional shape may be distributed such that the mass is not balanced with respect to the fixation point. In these embodiments of the cross-sectional shape, the center of mass may be on either first or second side with respect to the mass balance line. For these embodiments, in addition to the above, a required additional mass for balancing the mass of that cross-sectional shape may be defined having a secondary center of mass positioned on the opposite side of the mass balance line with respect to the center of mass, and at a second distance from the fixation point such that a final center of mass of the luminaire may coincide with the fixation point of that cross-sectional shape. This alternative may be best suited for relatively complex cross-sectional shapes of the luminaire wherein sectoring the cross-sectional shape may not be feasible for all angles. This alternative may give a higher freedom for choosing a desired 3D form of a luminaire. It may be that a combination of both alternatives is used for determining an intended extrusion of a cross sectional-shape of the luminaire.

Therefore, in both alternatives above, all final center of masses of all the cross-sectional shapes may coincide on the fixation line of the luminaire. This may lead to a balanced luminaire when vertically suspended from the suspension point.

Note that, each cross-sectional shape may represent an intended printing layer, or printing track of the luminaire. The cross-sectional shape may be a schematic, or conceptual visualization of the intended printing layer. Therefore, unless stated otherwise these terms may be used to convey the same meaning in the context of this invention.

According to a second aspect of the invention, there is provided a 3D-printing apparatus for production of a luminaire via 3D printing, wherein the luminaire is intended for vertical suspension. The 3D-printing apparatus comprises a printer head comprising a printer nozzle, configured to extrude a 3D-printing material. The 3D-printing apparatus further comprises a control system coupled to the printer head for controlling an extrusion of the 3D-printing material, wherein the control system, based on a suspension point of the luminaire, the suspension point being an exterior point of the luminaire by which the luminaire is intended to be vertically suspended, a fixation line through the luminaire, the fixation line elongating from the suspension point and being parallel to a vertical axis, z, and a plurality of cross-sectional shapes of the luminaire along the vertical axis, z, wherein each cross-sectional shape of the plurality of cross-sectional shapes extends in a plane, P, perpendicular to the vertical axis, z, and corresponds to a 3D-printing layer of the luminaire, is configured to, for each cross-sectional shape of the plurality of cross-sectional shapes of the luminaire: define a fixation point as the intersection of the fixation line with the cross-sectional shape, define a mass balance line in the plane, P, wherein the mass balance line intersects the fixation point, define a first side and a second side of the cross-sectional plane with respect to the mass balance line, respectively, wherein the first side and the second side are arranged oppositely each other with respect to the mass balance line, define a sector angle, dφ=180°/n, wherein n is an integer, wherein for each angle φ=k·dφ, wherein k=1, . . . , n, determine an extrusion of 3D-printing material of the cross-sectional shape as a function of a first sector, S₁, of the sector angle, dφ, at the angle, φ, in the first side, wherein the first sector, S₁, is associated with a first mass, m₁, of extruded 3D-printing material, and a second sector, S₂, of the sector angle, dφ, at the angle φ+180°, in the second side, wherein the second sector, S₂, is associated with a second mass, m₂, of extruded 3D-printing material, for minimizing a distance, R₀, between the fixation point and a center of mass, Mₜ, of the first sector, S₁, and the second sector, S₂, and in case the distance, R₀, exceeds a predetermined threshold distance, Rₜ, define a connection line in the plane, P, intersecting the center of mass, Mₜ, and the fixation point, wherein, in case the center of mass, Mₜ, is located in the first side, determine an additional extrusion of 3D-printing material of the cross-sectional shape in the second side such that a first center of mass, M_{S1}, of the determined additional extrusion of 3D-printing material of the cross-sectional shape of the second side coincides with the connection line in the second side and is located at a first distance, R_{S1}, from the fixation point, for minimizing |M_{S1}·R_{S1}−Mₜ·R₀|, and wherein, in case the center of mass, Mₜ, is located in the second side, determine an additional extrusion of 3D-printing material of the cross-sectional shape in the first side such that a second center of mass, M_{S2}, of the determined additional extrusion of 3D-printing material of the cross-sectional shape of the first side coincides with the connection line in the first side and is located at a second distance, R_{S2}, from the fixation point, for minimizing |M_{S2}·R_{S2}−Mₜ·R₀|.

The nozzle may be controlled to extrude more than one type of 3D-printing material, each with a certain material density, together, or alternatively, one at a time. The mass of the extruded material is related to the material density. Hence, depending on which material is extruded, the mass of the extruded material may be controlled. The controller may control the extrusion width, also known as the track width of the extruded 3D-printing material. The width of extruded 3D-printing material is perpendicular to a direction of extrusion of the 3D-printing material. The extrusion width may ultimately determine how much of a certain 3D-printing material is extruded, thus determining the mass of the extruded material. The density of all of the available 3D-printing materials to the 3D-printer, and additionally the total density of available combinations of material are known, and may be for instance, stored in a memory compartment, and recalled when needed by the controller. Similarly, the amount of mass for each extruded width of any of the available material and/or their combinations may be known or readily calculated by the controller.

The method according to the first aspect of the invention is for providing a luminaire having: a suspension point, being an exterior point of the luminaire from which the luminaire is intended to be suspended, a vertical axis intersecting the suspension point and being parallel to the direction of the gravitational field when the luminaire is suspended from the suspension point, and a plurality of cross-sectional shapes, each cross-sectional shape extending in a plane perpendicular to the vertical axis, and the plurality of cross-sectional shapes being non-rotationally symmetric with respect to the vertical axis. Each cross-sectional shape corresponds to a 3D-printed layer, the 3D-printed layer having k sets of a first sector and an associated second sector located opposite to each other with respect to a fixation point, the fixation point being an intersection of the vertical axis with the cross-sectional shape. Each of the first sector and the second sector is an arc of the cross-sectional shape subtending an angle dφ with the fixation point, the angle dφ being equal to 180°/k. The first sector is associated with a first mass of extruded 3D printing material, and the second sector is associated with a second mass of extruded 3D printing material, and wherein the first mass and the second mass have a center of mass that substantially coincides with the fixation point.

According to an embodiment, the determining of an extrusion of 3D-printing material is based on a track width, tw, of extruded 3D-printing material perpendicular to a direction of extrusion of the 3D-printing material.

The luminaire that can be provided with the method according to the first aspect of the invention is intended to be at least partially hollow, and, in at least one cross-sectional shape of the plurality of cross-sectional shapes, is intended to comprise at least one layer of 3D-printing material in a radial direction of the cross-sectional shape. It may be that a lower portion of the luminaire is intended open, so that light emitted inside the luminaire may directly exit the luminaire. Additionally, or alternatively, it may be that intermediate portions of the luminaire are intended to be hollow, constituting cavity-like structures.

At least one cross-sectional shape of the plurality of cross-sectional shapes, is intended to comprise a single layer track of 3D-printing material. It is noted that in the context of this invention, the terms layer track and printing track, or printing track layer are used to imply the same meaning, unless stated otherwise. For the luminaire, at least a cross-sectional shape, and/or at least a portion of a cross-sectional shape of the may be intended to be a single-wall structure, meaning that, a single extrusion width of material will define the printing layer in that cross-section, or that portion, respectively.

According to an embodiment, the step of determining the extrusion of 3D-printing material comprises, based on an intended extrusion of 3D-printing material along a first chord length, Δl₁, of the first sector, S₁, with a first track width, tw₁, of the 3D-printing material, and along a second chord length, Δl₂, of the second sector, S₂, with a second track width, tw₂, of the 3D-printing material, determining a first ratio, R₁, between the first track width, tw₁, and the second track width, tw₂, such that R₁=(ρ₂·Δl₂·r₂)/(ρ₁·Δl₁·r₁) is fulfilled, wherein r₁ is the sector radius of the first sector, S₁, r₂ is the sector radius of the second sector, S₂, ρ₁ is the density of 3D-printed material along the first chord length, Δl₁, and ρ₂ is the density of 3D-printed material along the second chord length, Δl₂. When attempting to solve the mass-balance equation for each pair of first and second sectors of the cross-sectional shape of an embodiment where a single layer track of 3D-printing material defines the cross-sectional shape, R₁ may be derived. R₁ defines the ratio of the second width to the first width of 3D-printing material intended to be extruded from the nozzle. In the case of the single layer track of 3D-printing material is intended to be from the same 3D-printing material or the same combination of 3D-printing material, the material density will be the same for the extruded material in each sector, hence rendering the track width an important factor in establishing the mass balance. Alternatively, it may be that a portion of a cross-sectional shape is defined by a single track layer, such as for instance in a luminaire with a solid inner section and a single wall surrounding it, or for instance a solid portion on a certain side, and a single wall on the other side of the same cross-sectional shape. In all of these embodiments, the extrusion width may be a determining factor, especially on the portion that have a single wall structure.

At least one cross-sectional shape of the plurality of cross-sectional shapes, may be intended to comprise a plurality of tracks of 3D-printing material in the radial direction of the cross-sectional shape. It may be that a cross-sectional shape comprises a plurality of walls. It may be that the entire cross-sectional shape is comprised of a multiple walled shape. Alternatively, it may be that a portion of the cross-sectional shape is comprised of a plurality of walls. The material density and the track width of each of the walls may be taken into consideration when attempting to solve the mass-balance equation.

According to an embodiment, the step of determining the extrusion of 3D-printing material comprises, based on an intended extrusion of 3D-printing material along a plurality of first chord lengths, Δl₁ᵢ, of the first sector, S₁, wherein the plurality of first chord lengths, Δl₁ᵢ, comprises an innermost first chord length, Δl₁ₗ, and an outermost first chord length, Δl₁ₙ, with respect to a first sector radius, r₁, of the first sector, S₁, and along a plurality of second chord lengths, Δl₂ᵢ, of the second sector, S₂, wherein the plurality of second chord lengths, Δl₂ᵢ, comprises an innermost second chord length, Δl₂₁, and an outermost second chord length, Δl₂ₙ, with respect to a second sector radius, r₂, of the second sector, S₂, determining a second ratio, R₂, between a first density, ρ₁, of the first sector S₁, and a second density, ρ₂, of the second sector S₂, such that R₂=(Δl₂ₙ·r_{2c}·Δᵣ₂)/(Δl₁ₙ·r_{1c}·Δr₁) is fulfilled, wherein Δr₁ is the radius length between a center point of the innermost first chord length, Δl₁₁, and the outermost first chord length, Δl₁ₙ, Δr₂ is the radius length between a center point of the innermost second chord length, Δl₂₁, and the outermost second chord length, Δl₂ₙ, r_{1c} is the radius from the fixation point to a first center point, Cᵣ₁, of a first area, A₁, defined by Δl₁ₙ and Δr₁, and r_{2c} is the radius from the fixation point to a second center point, Cᵣ₂, of a second area, A₂, defined by Δl₂ₙ and Δr₂.

The area confined in between adjacent walls of a cross-sectional shape in the first and second sectors may need to be taken into consideration when solving the mass-balance equation. The plurality of walls may have an innermost wall and an outermost wall, which would then in turn have a first and second innermost chord comprising an innermost chord length, and a first and second outermost chord comprising an outermost chord length.

According to an embodiment, the step of determining the extrusion of 3D-printing material is further based on an intended extrusion of filler material between the intended extrusion of 3D-printing material of the first sector, S₁, with respect to the first sector radius, r₁, of the first sector, S₁, and on an intended extrusion of filler material between the intended extrusion of 3D-printing material of the second sector, S₂, with respect to the second sector radius, r₂, of the second sector, S₂.

The area confined between the adjacent walls may be filled with a filler material, such as air, or any 3D-printing material available to the printer. The material will have a material density, which then may be taken into consideration when solving the mass balance equation. When solving the mass-balance equation of a multi-walled cross-sectional shape, the ratio R₂ may be derived. R₂ is the ratio between the total material density of the first sector to the total material density in the second sector. The total material density may include the material density of the filler material, as well as the material density of each of the printing layers defining each of the walls of the plurality of walls. In embodiments where the walls are intended to be of the same 3D-printing material, the first and second total material densities may merely represent the filler material densities. In embodiments wherein the filler material is the same in both sectors, and/or within each of the adjacent walls, then the first and second total material densities may represent the printing track material density. In some embodiments it may be that the extrusion width of the material for each of the walls are varied. In these embodiments, the extrusion widths of the walls in the first and second sectors may also need to be taken into consideration.

The luminaire that can be provided by the method according to the first aspect of the invention may be intended to be at least partially solid, and, in at least one cross-sectional shape of the plurality of cross-sectional shapes, is intended to comprise a plurality of tracks of 3D-printing material. The first and second sectors will each define an area in this embodiment, which should be mass-balanced. In these embodiments of the cross-sectional shape the extrusion width of material may not significantly impact the mass since the extruded material will all be conjoined to form a solid shape. Therefore, it may not be necessary to take it into consideration when solving the mass-balance equation. The determining factor may then be the 3D-printing material density. In some embodiments it may be that the intended extrusion width of the outermost printing track of the solid shape is varied, in order to manipulate the mass on a portion of the cross-sectional shape. In these embodiments, the track width of the outermost printing layer in the first and second sectors may also be included in the mass balance ratio.

According to an embodiment, the step of determining the extrusion of 3D-printing material comprises determining a third ratio, R₃, between a first density, ρ₁, of 3D-printing material of the first sector, S₁, and a second density, ρ₂, of 3D-printing material of the second sector S₂, such that R₃=r₂²/r₁² is fulfilled, wherein r₁ is the sector radius of the first sector, and r₂ is the sector radius of the second sector, S₂.

Solving the mass-balance equation for these embodiments will lead to the ratio R₃. R₃ is the ratio of the 3D-printing material density of the material within the area of the first sector to the 3D-printing material density of the material within the area of the second sector.

According to an embodiment, a fourth ratio, R₄, between a maximum width, twₘₐₓ, and a minimum width, twₘᵢₙ, of extruded 3D-printing material, respectively, perpendicular to a direction of extrusion of the 3D-printing material, fulfills R₄<3.

According to an embodiment, a minimum width, twₘᵢₙ, of extruded 3D-printing material fulfills 0.1 mm<twₘᵢₙ<1.6 mm.

The 3D-printer may have a process window of extrusion width ranging between for example 0.1 mm to 5 mm. This process window may be referred to as the nominal extrusion width range of the 3D printer, which may define the absolute minimum and the absolute maximum of extrusion widths the nozzle may extrude material in. However, this value is limited by R₄ as mentioned above. This limitation may then give a real extrusion width range of the printer between 0.1 mm and 1.6 mm.

It is noted that the invention relates to all possible combinations of features recited in the claims.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIGS. 1a and 1b schematically show a 3D-printed luminaire that can be provided by the method according to an exemplifying embodiment of the present invention, and

FIGS. 2-6 schematically show cross-sectional shapes of 3D-printed luminaires that can be provided by the method according to exemplifying embodiments of the present invention.

### DETAILED DESCRIPTION

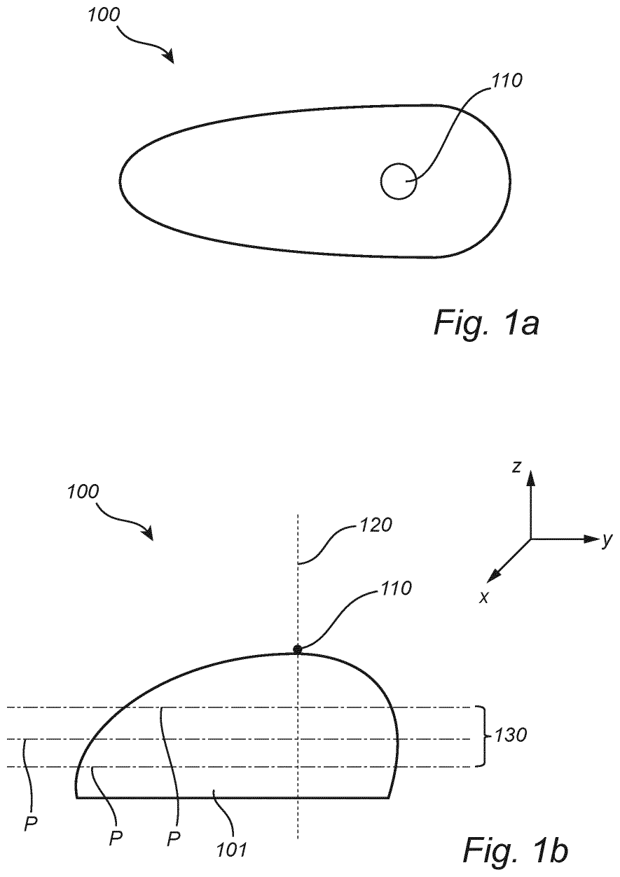

FIGS. 1a and 1b schematically demonstrate a 3D-printed luminaire 100 from the top, and side views, respectively. A suspension point 110 on the exterior of the luminaire 100 can be seen, from which the luminaire 100 is intended to be vertically suspended by a cord, or rope, or similar, along a fixation line 120. It is intended that when suspended, the luminaire 100 is balanced, such that an opening 101 of the luminaire 100 may be parallel to the x-y plane. In order to achieve this in the context of this invention, a numerical method is used to solve a mass-balance equation (defined more in detail below), e.g. by a computer program, after which a 3D-printer may execute the achieved results for 3D-printing the luminaire 100. For this purpose, initially a 3D shape of the luminaire 100 is defined, which is then divided into a plurality of cross-sectional shapes 130 extending in planes P perpendicular to the z axis. Each of these cross-sectional shapes 130 are intended to represent a single 3D-printed layer of the produced luminaire 100.

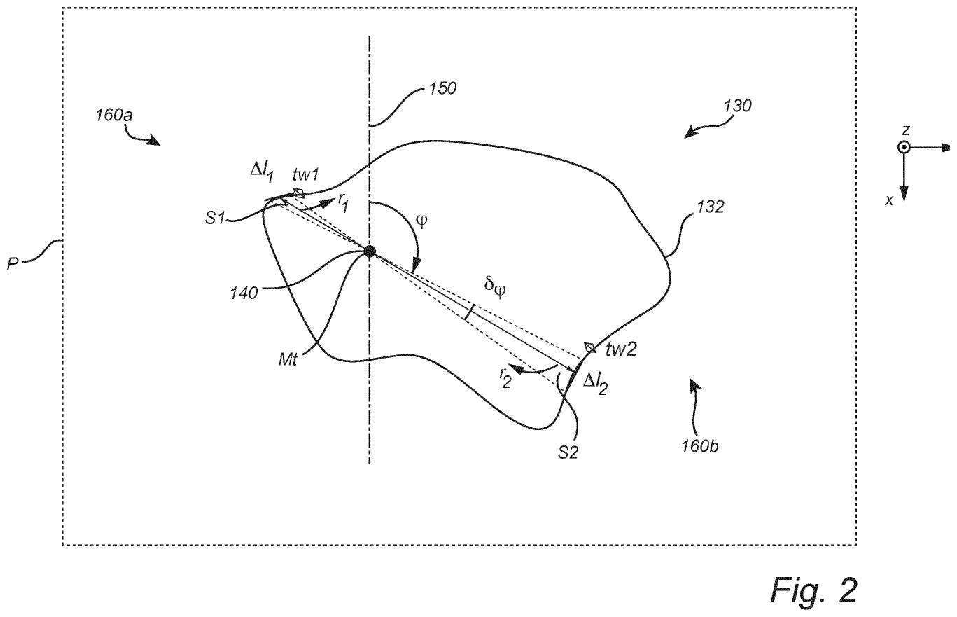

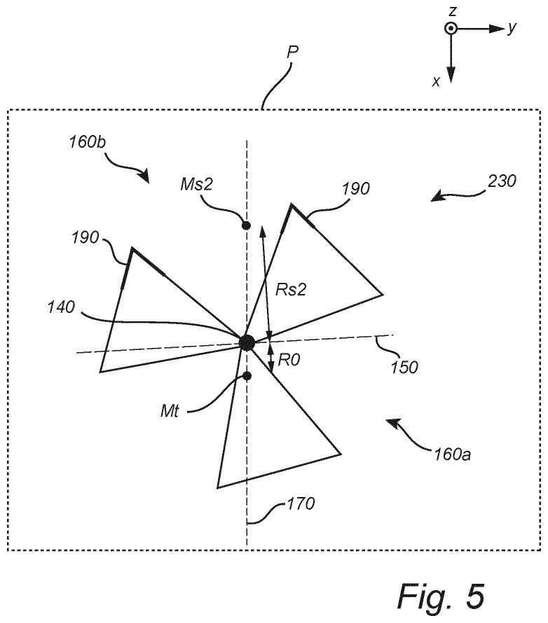

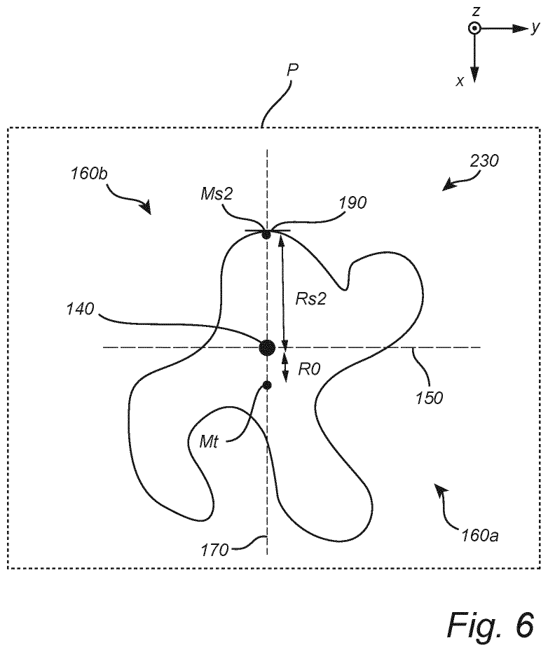

For each cross-sectional shape 130 of the plurality of cross-sectional shapes 130, the intended mass thereof is balanced with respect to a fixation point 140 shown in FIGS. 2 through 5, which is defined as the intersection of the fixation line 120 with the cross-sectional shape 130. For each cross-sectional shape 130, 230 the mass is intended to be distributed in a manner so that the distance R₀ between the fixation point 140 and the center of mass of the luminaire Mₜ is minimized, preferably equated to zero, so that the mass is balanced with respect to the fixation point 140. Since the extent of which R₀ can be minimized, the mass can be balanced in each cross-sectional shape 130, 230. This is intimately related to the specific 2D shape of that cross-section 130 of the luminaire 100, and there may be a need for additional steps of the numerical method used for solving the mass balance equation for some cross-sectional shapes 130, 230. This is due to that in certain embodiments of the cross-sectional shape 130, 230 the minimized distance R₀ remains larger than a predefined threshold value Rₜ. Therefore, additional steps may be needed in order to coincide the center of mass Mₜ with the fixation point 140. In the context of this invention two main approaches are used, the first approach being the main approach, and the second approach comprising the mentioned additional steps in order to achieve the desired minimization of R₀. In the following, for each of the two approaches exemplifying embodiments are given in the remaining figures. The first and main approach is typically sufficient for solving mass balance equations for luminaires 100 with cross-sectional shapes 130 that are quasi-circular such as those shown in FIGS. 2-4, such that the periphery of the cross-section 130 does not intersect itself, and/or any given intersecting line in the plane P, does not intersect the cross-sectional shape 130 in more than two points. For other cross-sectional shapes 230 such as that shown in FIGS. 5 and 6, the second approach is used.

As mentioned, in general, both approaches are based on solving the mass-balance equation such that a final center of mass Mₜ of the intended 3D-printing layer coincides with the fixation point 140 of the cross-sectional shape 130, 230.

For this purpose, a predefined initial 3D-printing material and extrusion width is used for calculating the center of mass Mₜ, which the 3D-printed layer of that cross-sectional shape 130, 230 would have:

$${\sum }_{i} {m}_{i} ( {r}_{i} - {R}_{o} ) = 0$$

Wherein R₀ is the distance between the center of mass Mₜ, and the fixation point 140, mᵢ represents the mass at every specific location “i” on the cross-sectional shape 130, 230, and r₁ is the distance of that specific location from the fixation point 140. These initial values may be default values stored in a memory system of a computer. Alternatively, they may be values defined by a user for a given luminaire 100. As shown in FIGS. 2-4, a mass balance line 150 is defined in plane P, such that it traverses the fixation point 140 of the cross-sectional shape 130. A first side 160a, and an opposite second side 160b of the cross-sectional shape 130 is defined with respect to the mass balance line 150. An intended extrusion of 3D-printing material is calculated so that the final center of mass Mₜ would coincide with the fixation point 140. In other words, it is intended that a total effective mass of the first side will equal a total effective mass of the second side, so that a final total center of mass Mₜ will coincide with the fixation point 140.

In the following, each of the approaches are described in detail.

For solving the mass-balance equation according to the first and main approach, an intended extrusion of 3D-printing material is calculated so that the final center of mass Mₜ would coincide with the fixation point 140. In other words, R₀ will then be close to zero, or equal to zero, so that Mₜ will be shifted to the fixation point 140. According to the first approach, a sector angle δφ is chosen for the cross-sectional shape 130. This sector angle δφ determines the number steps which the mass-balance equation will be solved. Each step is defined by an angle φ=k·δφ, wherein k=1 . . . , n. Starting from the mass-balance line 150, with k=1 on the first side 160a, a first sector S₁ with a sector angle of δφ is defined. On the second side 160b, and with a mirrored symmetry with respect to the mass-balance line 150, a second sector S₂ is defined symmetrical to the first sector S₁ and with a sector angle of δφ. Each sector S₁, S₂ has a sector radius r₁, r₂, which is defined as the distance of the cross-sectional shape 130 confined by the sector to the fixation point 140. The mass of the first sector S₁ and the second sector S₂ is then balanced with respect to an intended extrusion width, material density, and sector radius of each side. This is repeated for all steps, so that in each step the first sector S₁ is mass balanced with its symmetrical second sector S₂. A few exemplifying embodiments are given in FIGS. 2-4 with different intended structures and 3D-forms of the luminaire 100.

FIG. 2 demonstrates a cross-sectional shape 130 of the luminaire 100 with a quasi-circular closed loop shape. It is intended that at the cross-sectional shape 130 represents a single track of 3D-printing material 132, meaning that at least that portion of the luminaire 100 defined by this cross-sectional shape 130 is intended to have a single-wall structure. Thus, the mass will be determined by the material density (p), and the extrusion width of the 3D-printing material (tw), also known as the track width in each of the first and second sectors S₁, S₂ of each step. The segment of the cross-sectional shape defined by the first sector S₁ and the second sector S₂ can be defined by a chord, having a chord length Δl₁ and Δl₂, respectively. Consequently, solving the mass balance equation will derive a ratio R₁ between the first and second sector as R₁=tw₁/tw₂=(ρ₂·Δl₂·r₂)/(ρ₁·Δl₁·r₁), wherein tw₁ is the extrusion width of the 3D-printing material in the first sector S₁, and tw₂ is the extrusion width of the 3D-printing material in the second sector S₂. In an embodiment, it may be that one type of material with a given material density is intended to be used for 3D-printing the 3D-printing layer represented by the cross-sectional shape 130. In this case, the material density of the 3D-printing material of the first sector S₁ will be equal to that of the second sector S₂: ρ₁=ρ₂, and thus the mass-balance ratio will be simplified to: R₁=tw₁/tw₂=(Δl₂·r₂)/(Δl₁·r₁). By solving this for each pair of first and second sectors S₁, S₂, the mass will be distributed such that that the final center of mass Mₜ will coincide with the fixation point 140.

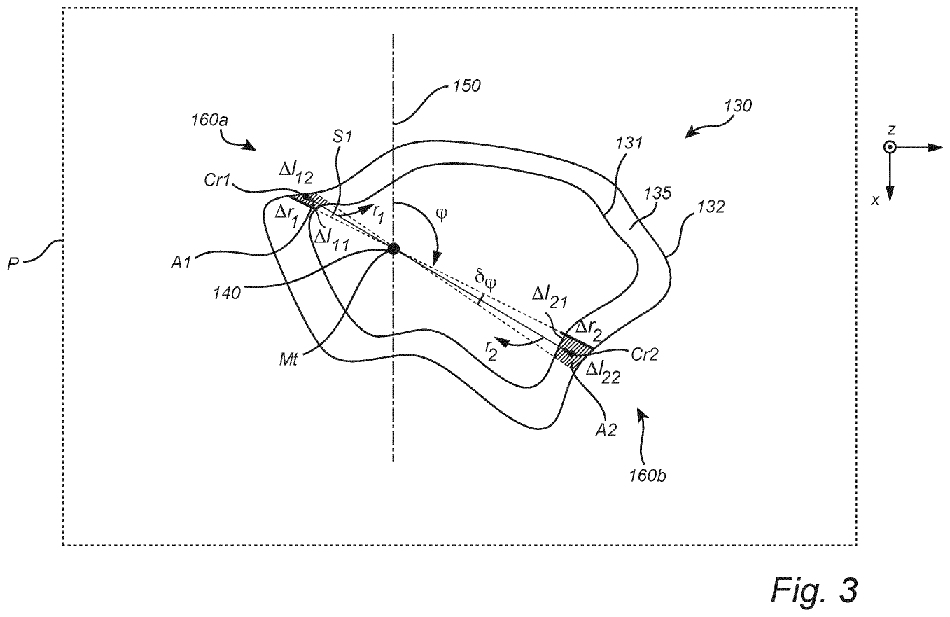

FIG. 3 depicts a cross-sectional shape 130 of an embodiment of the luminaire 100, wherein at least that portion of the luminaire 100 that is represented by that cross-sectional shape 130 is intended to have a two-wall structure, meaning that a double track of printing material 131, 132 will define the shape of that 3D-printing layer. The space 135 encapsulated in between the first 131 and the second 132 track of the 3D-printing material may be filled by one or more filler materials, such as for instance air, or any other material. Each of the filler materials will have a certain material density, which will be taken into account when balancing the mass of the first sector S₁ and the second sector S₂ for each step. For this purpose, again a first sector S₁ and a symmetrical second sector S₂ will be defined on the first 160a and second 160b sides of the mass-balance line 150 with a sector angle of δφ. The segment of the first track 131 bordered by the first and second sectors S₁, S₂ can be defined by a first inner chord having a first inner chord length of Δl₁₁ and a second inner chord having a second inner chord length of Δl₂₁, respectively. The second printing track 132 defined by the first and second sectors S₁, and S₂, will similarly have a first outer chord corresponding to a first outer chord length Δl₁₂ and a second outer chord corresponding to a second outer chord length Δl₂₂, respectively. The distance between the first and second printing tracks 131, 132 is given by a radius length Δr₁, and Δr₂ for the first and second segments respectively, and is defined as the length between a center point of the first inner chord length Δl₁₁ and the center point of the first outer chord length Δl₁₂, and the length between a center point of the second inner chord length Δl₂₁ and the center point of the second outer chord length Δl₂₁, respectively. The material density areas A₁, A₂ confined between the first and second printing tracks 131, 132, and defined by the first and second sectors S₁, S₂, will be taken into consideration in the mass-balance ratio. Assuming that the first and second printing tacks 131 and 132 have a uniform extrusion width around the entire track, then solving the mass balance ratio will result in a ratio R₂ between the density ρ₁ of the filler material in the first sector S₁, and the density ρ₂ of the filler material in the second sector S₂, will be as follows: R₂=ρ₁/ρ₂=(Δl₂₂·r_{2c}·Δr₂)/(Δl₁₂·r_{1c}·Δr₁), wherein, r_{1c} is the first sector radius and is defined from the fixation point 140 to a first center point Cr1 in the first area A₁, and r_{2c} is the first sector radius and is defined from the fixation point 140 to a second center point Cr1 in the second area A₂.

It is worth noting that, the filler material except for air, will of course also be extruded by the 3D-printer, and the choice of terminology is not meant to convey otherwise.

It may be that the filler material extruded by the 3D-printer may also comprise multiple printing tracks of filler material. Additionally, or alternatively, the multiplicity of filler material printing tracks may be intended to be deposited according to a predetermined pattern. In these embodiments the density of the filler material may be adjusted by changing the number and/or the track width of the filler material printing tracks in order to achieve the desired mass balance.

It may be that first printing track 131 and the second printing track 132 can be intended to have the possibility of varying the extrusion widths tw₁, tw₂. In this case, the extrusion width of either or both of the printing tracks 131, 132 can be taken into account in the mass-balance equation.

Some embodiments of the luminaire 100 may comprise multiple printing tacks, leading to a multi-walled structure. In these luminaires 100, when solving the mass-balance equations in the multiple track cross sections, the density of the filler material confined between each consecutive printing track should be taken into consideration.

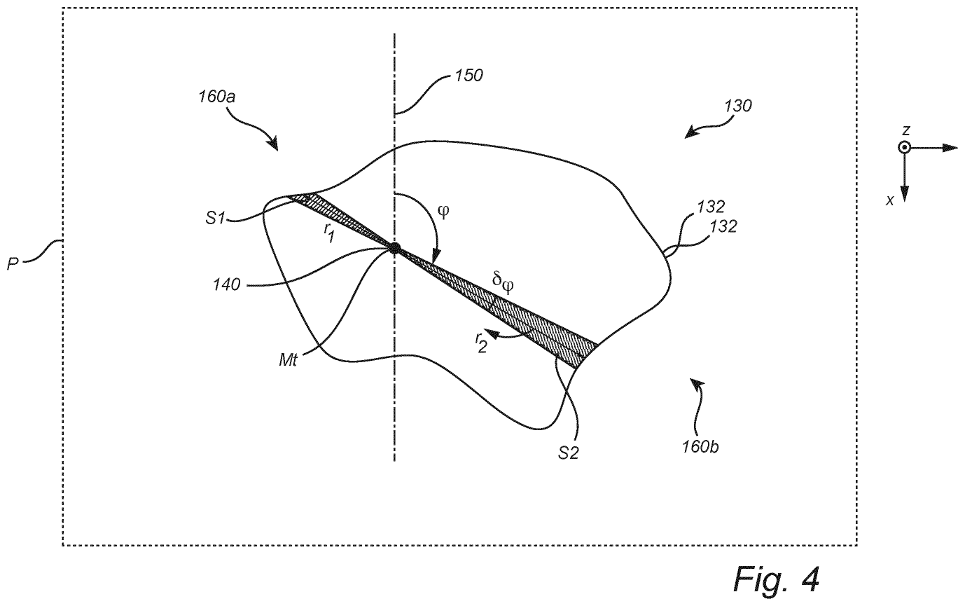

FIG. 4 demonstrates a cross-sectional shape 130 of the luminaire which has a solid mass throughout the entire cross-section 130. In other words, the cross-sectional shape 130 is a plane consisting a plurality of 3D-printing tracks with no spacings, and/or filler material between them. In this embodiment therefore, the extrusion widths tw₁, tw₂ of the first and second sectors S₁, S₂ will not have a significant role in determining the mass of the sectors S₁, S₂, hence will not be considered in the mass-balance equation. Solving the mass-balance equation for this embodiment will lead to a ratio R₃ between the density ρ₁ of the 3D-printing material of the first sector S₁, and the density ρ₂ of the 3D-printing material of the second sector S₂ as follows: R₃=ρ₁/ρ₂=r₂²/r₁², wherein r₁ is the sector radius of the first sector S₁, and r₂ is the sector radius of the second sector S₂.

It should be noted that within a cross-sectional shape 130, a portion of the cross-sectional shape 130 may be intended to be solid similar to that shown in the embodiment of FIG. 4, while other portions are meant to be single or alternatively multiple walled structures, for instance surrounding the solid structure. Additionally, or alternatively it may be that the space between the walls and/or between the solid structure and the innermost wall is intended to comprise a filler material. In these embodiments, in addition to R₃, R₁, and possibly R₂ need to be taken into consideration when solving the mass-balance equation.

The first approach may not suffice for achieving the necessary minimization of R₀ for certain embodiments of the luminaire 100 such as those shown in FIGS. 5 and 6. In FIG. 5 for instance, in at least some rotational degrees the luminaire 100 does not have a cross-sectional shape 230 trajectory on which the 3D-printing material may be extruded. Therefore, when dividing the cross-sectional shape 230 into sectors, it is inevitable that some sectors will remain without any substantial cross-sectional portion that is defined by that sector, which would render it impossible to substantiate any intended mass in those sectors in order to mass-balance the two sectors. For these embodiments the second approach is used for balancing the mass such that a final center of mass Mₜ is defined coinciding with the fixation point 140. In the second approach, similar to the first approach, initially the center of mass Mₜ is calculated for a given 3D-printing material extrusion width and density. In addition to the sector by sector mass balancing steps of the first approach, depending on the side which with respect to the mass balance line 150 the center of mass Mₜ falls onto, i.e. the first side 160a, or the second side 160b, additional mass may be provided on the opposite first side 160b, or second side 160a, respectively in order to balance the mass with respect to the fixation point 140. This additional mass will have a secondary center of mass M_{S2}, or M_{S1} on the opposite side first side 160b, or second side 160a, which in order to balance the center of mass Mₜ such that the final center of mass Mₜ is defined on the fixation point, is required to be on a connection line 170 which traverses both the fixation point 140 and the original center of mass M₀. An intended extrusion of the 3D-printing material will then be calculated depending on the radius R_{S2}, or R_{S1} of the secondary center of mass M_{S2}, or M_{S1}, and the radius of the center of mass from the fixation point: M_{S2}·R_{S2}=Mₜ·R₀, or M_{S1}·R_{S1}=Mₜ·R₀. The calculated intended additional mass 190 will then be distributed equally on either side of the connection line 170 on the side where the secondary center of mass M_{S2}, or M_{S1} is located. This intended additional mass 190 may be intended to be implemented by a larger track width of 3D-printing material, and/or a higher density of material compared to that of the remainder of the cross-sectional shape 230.

In the embodiment depicted in FIG. 5, the center of mass Mₜ is located on the first side 160a. The connection line 170 does not traverse any portion of the cross-sectional shape 230 on the second side 160b. Therefore, the additional mass 190 may be distributed equally on either side on the connection line 170 on the second side 160b such that the secondary center of mass M_{S2} is located on the second side 160b and on the connection line 170.

In the embodiment of FIG. 6, the center of mass Mₜ is again located on the first side 160a. The connection line 170 traverses the cross-sectional shape 230 on the second side 160b. Additionally in this embodiment, it is intended that the secondary mass is distributed such that the secondary center of mass M_{S2} falls onto the cross-sectional shape 230. This can be achieved by taking the amount of the original intended mass, and the radius of the original center of mass R₀ into account. Additionally, by defining the distance from the fixation point 140 to the intersection of the secondary mass balance line 150 with the cross-sectional shape 230, as the radius of the second center of mass R_{S2}, the amount of the intended additional mass can be calculated to be such that it fits the above-mentioned equation. Since the secondary center of mass M_{S2} in fact falls on to the cross-sectional shape 230 itself, instead of balancing the intended additional mass on the second side 160b and on either side of the connection line 170, in the embodiment shown in FIG. 6, the additional mass 190 is intended to be extruded on and adjacent to the secondary center of mass M_{S2}.

The person skilled in the art realizes that the present invention by no means is limited to the preferred embodiments described above. On the contrary, many modifications and variations are possible within the scope of the appended claims. For example, . . . .

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A method for determining a production of a luminaire via 3D-printing, wherein the luminaire is intended for vertical suspension, the method comprising the steps of
defining a suspension point, of the luminaire, the suspension point being an exterior point of the luminaire by which the luminaire is intended to be vertically suspended,
defining a fixation line through the luminaire, the fixation line elongating from the suspension point and being parallel to a vertical axis, z,
defining a plurality of cross-sectional shapes of the luminaire along the vertical axis, z, wherein each cross-sectional shape of the plurality of cross-sectional shapes extends in a plane, P, perpendicular to the vertical axis, z, and corresponds to a 3D-printing layer of the luminaire,
and for each cross-sectional shape of the plurality of cross-sectional shapes of the luminaire:
a) defining a fixation point as the intersection of the fixation line with the cross-sectional shape,
b) defining a mass balance line in the plane, P, wherein the mass balance line intersects the fixation point,
c) defining a first side and a second side of the cross-sectional shape with respect to the mass balance line, respectively, wherein the first side and the second side are arranged opposite to each other with respect to the mass balance line,
d) defining a sector angle, dϕ=180°/n, wherein n is an integer,
wherein for each angle ϕ=k·dϕ, wherein k=1, . . . , n
e) determining an extrusion of 3D-printing material of the cross-sectional shape as a function of
a first sector, S₁, of the sector angle, dϕ, at the angle, ϕ, in the first side, wherein the first sector, S₁, is associated with a first mass, m₁, of extruded 3D-printing material, and
a second sector, S₂, of the sector angle, dϕ, at the angle ϕ+180°, in the second side, wherein the second sector, S₂, is associated with a second mass, m₂, of extruded 3D-printing material,
for minimizing a distance, R₀, between the fixation point and a center of mass, Mₜ, of the first sector, S₁, and the second sector, S₂,
and in case the distance, R₀, exceeds a predetermined threshold distance, Rₜ,
f) defining a connection line in the plane, P, intersecting the center of mass, Mₜ, and the fixation point,
wherein, in case the center of mass, Mₜ, is located in the first side,
determining an additional extrusion of 3D-printing material of the cross-sectional shape in the second side such that a first center of mass, M_{S1}, of the determined additional extrusion of 3D-printing material of the cross-sectional shape of the second side coincides with the connection line in the second side and is located at a first distance, R_{S1}, from the fixation point, for minimizing |M_{S1}·R_{S1}−Mₜ·R₀|,
and wherein, in case the center of mass, Mₜ, is located in the second side,
determining an additional extrusion of 3D-printing material of the cross-sectional shape in the first side such that a second center of mass, M_{S2}, of the determined additional extrusion of 3D-printing material of the cross-sectional shape of the first side coincides with the connection line in the first side and is located at a second distance, R_{S2}, from the fixation point, for minimizing |M_{S2}-R_{S2}-Mₜ-R₀|.

2. The method according to claim 1, wherein the determining of an extrusion of 3D-printing material is based on a track width, tw, of extruded 3D-printing material perpendicular to a direction of extrusion of the 3D-printing material.

3. The method according to claim 1, wherein the luminaire is intended to be at least partially hollow, and, in at least one cross-sectional shape of the plurality of cross-sectional shapes, is intended to comprise at least one layer of 3D-printing material in a radial direction of the cross-sectional shape.

4. The method according to claim 3, wherein the luminaire, in at least one cross-sectional shape of the plurality of cross-sectional shapes, is intended to comprise a single track of 3D-printing material.

5. The method according to claim 4, wherein the step of determining the extrusion of 3D-printing material comprises, based on an intended extrusion of 3D-printing material along a first chord length, Δl₁, of the first sector, S₁, with a first track width, tw₁, of the 3D-printing material, and along a second chord length, Δl₂, of the second sector, S₂, with a second track width, tw₂, of the 3D-printing material, determining a first ratio, R₁, between the first track width, tw₁, and the second track width, tw₂, such that R₁=(ρ₂·Δl₂·r₂)/(ρ₁·Δl₁·r₁) is fulfilled, wherein r₁ is the sector radius of the first sector, S₁, r₂ is the sector radius of the second sector, S₂, ρ₁ is the density of 3D-printed material along the first chord length, Δl₁, and ρ₂ is the density of 3D-printed material along the second chord length, Δl₂.

6. The method according to claim 3, wherein the luminaire, in at least one cross-sectional shape of the plurality of cross-sectional shapes, is intended to comprise a plurality of tracks of 3D-printing material.

7. The method according to claim 6, wherein the step of determining the extrusion of 3D-printing material comprises, based on an intended extrusion of 3D-printing material along a plurality of first chord lengths, Δl₁ᵢ, of the first sector, S₁, wherein the plurality of first chord lengths, Δl₁ᵢ, comprises an innermost first chord length, Δl₁₁, and an outermost first chord length, Δl₁ₙ, with respect to a first sector radius, r₁, of the first sector, S₁, and along a plurality of second chord lengths, Δl₂ᵢ, of the second sector, S₂, wherein the plurality of second chord lengths, Δl₂ᵢ, comprises an innermost second chord length, Δl₂₁, and an outermost second chord length, Δl₂ₙ, with respect to a second sector radius, r₂, of the second sector, S₂, determining a second ratio, R₂, between a first density, ρ1, of the first sector S₁, and a second density, ρ₂, of the second sector S₂, such that R₂=(Δl₂ₙ·r₂·Δr₂)/(Δl₁ₙ·r_{1c}·Δr₁) is fulfilled, wherein Δr₁ is the radius length between a center point of the innermost first chord length, Δl₁₁, and the outermost first chord length, Δl₁ₙ, Δr₂ is the radius length between a center point of the innermost second chord length, Δl₂₁, and the outermost second chord length, Δl₂ₙ, r_{1c} is the radius from the fixation point to a first center point, Cᵣ₁, of a first area, A₁, defined by Δl₁ₙ and Δᵣ₁, and r_{2c} is the radius from the fixation point to a second center point, Cᵣ₂, of a second area, A₂, defined by Δl₂ₙ and Δr₂.

8. The method according to claim 7, wherein the step of determining the extrusion of 3D-printing material is further based on an intended extrusion of filler material between the intended extrusion of 3D-printing material of the first sector, S₁, with respect to the first sector radius, r₁, of the first sector, S₁, and on an intended extrusion of filler material between the intended extrusion of 3D-printing material of the second sector, S₂, with respect to the second sector radius, r₂, of the second sector, S₂.

9. The method according to claim 1, wherein the luminaire is intended to be at least partially solid, and, in at least one cross-sectional shape of the plurality of cross-sectional shapes, is intended to comprise a plurality of tracks of 3D-printing material.

10. The method according to claim 9, wherein the step of determining the extrusion of 3D-printing material comprises determining a third ratio, R₃, between a first density, ρ1, of 3D-printing material of the first sector, S₁, and a second density, ρ₂, of 3D-printing material of the second sector S₂, such that R₃=r₂²/r₁² is fulfilled, wherein r₁ is the sector radius of the first sector, and r₂ is the sector radius of the second sector, S₂.

11. The method according to claim 1, wherein a fourth ratio, R₄, between a maximum track width, twₘₐₓ, and a minimum track width, twₘᵢₙ, of extruded 3D-printing material, respectively, perpendicular to a direction of extrusion of the 3D-printing material, fulfills R₄<3.

12. The method according to claim 1, wherein a minimum track width, twₘᵢₙ, of extruded 3D-printing material fulfills 0.1 mm<twₘᵢₙ<1.6 mm.

13. A 3D-printing apparatus for production of a luminaire via 3D-printing, wherein the luminaire is intended for vertical suspension, comprising
a printer head comprising a printer nozzle, configured to extrude a 3D-printing material, and
a control system coupled to the printer head for controlling an extrusion of the 3D-printing material, wherein the control system, based on a suspension point of the luminaire, the suspension point being an exterior point of the luminaire by which the luminaire is intended to be vertically suspended, a fixation line through the luminaire, the fixation line elongating from the suspension point and being parallel to a vertical axis, z, and a plurality of cross-sectional shapes of the luminaire along the vertical axis, z, wherein each cross-sectional shape of the plurality of cross-sectional shapes extends in a plane, P, perpendicular to the vertical axis, z, and corresponds to a 3D-printing layer of the luminaire, is configured to, for each cross-sectional shape of the plurality of cross-sectional shapes of the luminaire:
a) define a fixation point as the intersection of the fixation line with the cross-sectional shape,
b) define a mass balance line in the plane, P, wherein the mass balance line intersects the fixation point,
c) define a first side and a second side of the cross-sectional plane with respect to the mass balance line, respectively, wherein the first side and the second side are arranged oppositely each other with respect to the mass balance line,
d) define a sector angle, dϕ=180°/n, wherein n is an integer,
wherein for each angle ϕ=k·dϕ, wherein k=1, . . . , n
e) determine an extrusion of 3D-printing material of the cross-sectional shape as a function of
a first sector, S₁, of the sector angle, dck, at the angle, (I), in the first side, wherein the first sector, S₁, is associated with a first mass, m₁, of extruded 3D-printing material, and
a second sector, S₂, of the sector angle, &I), at the angle (1)+180°, in the second side, wherein the second sector, S₂, is associated with a second mass, m₂, of extruded 3D-printing material,
for minimizing a distance, R₀, between the fixation point and a center of mass, Mₜ, of the first sector, S₁, and the second sector, S₂,
and in case the distance, R₀, exceeds a predetermined threshold distance, Rₜ,
f) define a connection line in the plane, P, intersecting the center of mass, Mₜ, and the fixation point,
wherein, in case the center of mass, Mₜ, is located in the first side,
determine an additional extrusion of 3D-printing material of the cross-sectional shape in the second side such that a first center of mass, M_{S1}, of the determined additional extrusion of 3D-printing material of the cross-sectional shape of the second side coincides with the connection line in the second side and is located at a first distance, R_{S1}, from the fixation point, for minimizing |M_{S1}·R_{S1}−Mₜ·R₀|,
and wherein, in case the center of mass, Mₜ, is located in the second side,
determine an additional extrusion of 3D-printing material of the cross-sectional shape in the first side such that a second center of mass, M_{S2}, of the determined additional extrusion of 3D-printing material of the cross-sectional shape of the first side coincides with the connection line in the first side and is located at a second distance, R_{S2}, from the fixation point, for minimizing |M_{S2}·R_{S2}−Mₜ·R₀|.

14. A computer program comprising computer readable code for causing a computer to carry out the steps of the method according to claim 1 when the computer program is carried out on the computer.
